(19) United States
(12) Patent Application Publication
(10) Pub. No.: US 2008/0105483 A1
(43) Pub. Date: May 8, 2008

(54) VEHICLE PROPULSION SYSTEM ACTIVATION DEVICE

(76) Inventor: David Dugas, Mansfield, MA (US)

Correspondence Address: WINSTON & STRAWN LLP;PATENT DEPARTMENT, 1700 K STREET, N.W., WASHINGTON, DC, 20006, US

(21) Appl. No.: 11/762,609

(22) Filed: Jun. 13, 2007

Related U.S. Application Data
(63) Continuation of application No. PCT/US07/70954, filed on Jun. 12, 2007.
(60) Provisional application No. 60/813,363, filed on Jun. 14, 2006.

(51) Int. Cl. B60K 28/00; B60W 10/08; B60W 10/18

(52) U.S. Cl. 180/273; 477/27

(57) ABSTRACT

A vehicle propulsion system activation device having a plurality of sensors associable with user-manipulable portions of the vehicle, which switch the condition of the controller between conditions of pre-activation and activation. Interlock sensors detect the position of these portions and transmit signals to the controller confirming the sensed positions. Sequence sensors detect the start sequence entered by the user, and transmit the sensed sequence to the controller, which switches conditions of the controller to an activated condition and the state of the propulsion to an activated state upon confirmation of the predetermined sequence.

### CROSS-REFERENCE TO RELATED APPLICATION

This application claims the benefit of provisional application No. 60/813,363, filed on Jun. 14, 2006, and is a continuation of the International PCT Application entitled Vehicle Propulsion System Activation Device, filed on Jun. 12, 2007, the contents of which are hereby incorporated herein by reference thereto.

### FIELD OF THE INVENTION

The present invention relates generally to a vehicle having a propulsion system activation device. More particularly, the invention relates to a system operably connected to a propulsion system that senses the presence of predetermined parameters to activate the propulsion system.

### BACKGROUND OF THE INVENTION

Vehicles having a propulsion system, including, for example, a motor or an engine, are known. Conventionally these vehicles include a key and/or a start button to activate the propulsion systems such as to start the vehicle. Some of these vehicles have handle bar steering, and a throttle operably connected to control the power of the propulsion system. Some variations of these vehicles include vehicles having two, three, or more wheels, such as motorcycles, mopeds, scooters, all terrain vehicles (ATV's), and cars. Additional variations of these vehicles include wheel-less vehicles, such as jet skis, and other vehicles, such as snowmobiles. For the purposes of the present invention, these variations are referred to interchangeably herein for their commonality, and they are generally referred to herein as the “vehicle.”

Some aspects of vehicle safety have been addressed by improving operator (also referred to interchangeably herein as “driver,” “rider,” or “user”) awareness and training. Improvements to the design of these vehicles has also improved safety. Generally, these design improvements have focused on the rideability and performance of the vehicles, such as braking mechanisms and road handling, that are particularly pertinent to when the vehicle is already moving.

To start the propulsion system on conventional vehicles, an operator usually uses an unlocking device (e.g., a key) to turn a vehicle ignition switch to an ON position. Typically, a vehicle engine cut-off switch (i.e., a kill button) is set to a RUN position (e.g., conventionally a closed position, whereby an electrical signal between the kill switch and the propulsion system can be conducted). In many conventional vehicles, the operator squeezes a clutch lever with one hand and a start button is pressed with the other hand. The starter motor is allowed to turn over until the engine fires before the operator releases the start button.

In electric vehicles, often a single switch activates the motor, and it is possible to accidentally turn the throttle when a rider is attempting to mount the vehicle, such as in an electric scooter, leading to the danger of the vehicle accelerating away from the rider uncontrollably.

There is a need in the art for a safety mechanism that controls the propulsion system of the vehicle to help ensure that the rider is in a position to control the vehicle when started and/or that the rider actually intends to power the motor initially when the motor-power control is activated, to improve the safety of the operator and bystanders.

### SUMMARY OF THE INVENTION

The present invention advantageously provides a system to detect parameters that indicate that the rider is in a position to control the vehicle when started and/or that the rider actually intends to power the motor initially when the motor-power control is activated to improve the safety of the operator and bystanders. A preferred embodiment includes a plurality of sequence sensors, each associable with a plurality of user-manipulable portion of a vehicle for sensing positions thereof and transmitting a plurality of sequence signals based on the sensed positions. A controller has a pre-activation condition, which preferably includes “initial” and “ready” conditions. The controller is operably connected to the sequence sensors for receiving the transmitted sequence signals and switching to an activation condition upon receiving the sequence signals in a predetermined sequence. The controller is preferably connectable to the vehicle propulsion system for activating the propulsion system when in the activation condition. The predetermined sequence can include sequence signals that indicate that at least one of the user-manipulable portions is operated more than once in the sequence.

In the preferred propulsion system activation device, the controller has an “initial” condition in which the controller is configured for maintaining the propulsion system in a deactivated state. The device includes a plurality of interlock sensors that are configured for sensing a position of at least one user-manipulable portion of the vehicle and transmitting a plurality of interlock signals based on said sensed positions. The controller is configured to switch from the “initial” condition to the “ready” condition upon receiving all of the interlock sensor signals. Additionally, the controller can be configured such that receipt of the sequence signals from the sequence sensor does not switch to the activation condition unless the controller is in the “ready” condition when the predetermined sequence is detected.

A preferred vehicle includes a vehicle body, a seat on the body for supporting a rider, the propulsion system; a stand associated with the body to stabilize the body in an upright position when not mounted by the rider; a plurality of interlock system sensors configured for sensing the position of a vehicle stand and the weight of the rider on the seat and for transmitting sensor signals based on the sensed parameters; and a controller operably connected to the interlock sensors for receiving the sensor signals. The controller is configured for determining a ready condition based on the received sensor signals, and for placing the vehicle propulsion system in the ready condition.

A method of operating a vehicle, preferably includes, in a controller, detecting positions of at least one user-manipulable portion of a vehicle, switching the controller to a ready condition upon detection of predetermined positions of the user-manipulable portion. In the ready condition, the controller detects a sequence of operation of a plurality of user-manipulable portions of the vehicle and upon detection of said sequence matching a predetermined sequence, switching the controller to an activation condition. The controller activates the vehicle propulsion system when the controller is in the activation condition. Optionally, the method includes displaying the conditions of the propulsion system.

Thus, the invention improves safety of vehicle operation by reducing the occurrences of motive power being applied to the vehicle when the rider or driver is not in a position to control the vehicle.

### BRIEF DESCRIPTION OF DRAWINGS

Further advantageous features of the present invention will become more apparent with the following detailed description when taken with reference to the accompanying drawings in which:

FIG. 1 is a left side view of an embodiment of a scooter, constructed according to the invention;

FIG. 2 is a top view of the scooter of FIG. 1;

FIG. 3 is a view of an exemplary rider display console of the scooter of FIG. 1;

FIG. 4 is an overview flow diagram of the start process and exemplary system checks, in accordance with a preferred embodiment of the present invention;

FIG. 5 is a flow diagram of the system checks using the interlock safety sensor, in accordance with the preferred embodiment; and

FIG. 6 is a flow diagram of the system checks using the sequence safety sensor, in accordance with the preferred embodiment.

### DETAILED DESCRIPTION OF THE PREFERRED EMBODIMENTS

The present invention relates to a propulsion system activation device that involves a plurality of system checks before the vehicle propulsion system becomes operational, thereby enhancing vehicle safety. More specifically, the present invention includes the system, which is incorporated on the vehicle and ensures that certain requisites, particularly those related to safe handling during starting, are met before the vehicle can be powered. Accordingly, the present invention provides numerous safety advantages over the prior art, including ensuring that the operator is mounted on and in control of the vehicle at starting. Consequently, the present invention decreases the danger that an unattended vehicle would propel itself or inadvertently accelerate forward and limits the chances for the vehicle to be out of control of the operator during and after start up.

The system includes a series of sensors, which in the preferred embodiment include switches, such as two position switches that can open and close a circuit. In alternative embodiments; other types of sensors can be employed, such as sensors that detect a position of a user-manipulable portion of the vehicle throughout a range. The sensors are configured to detect orientations of the vehicle and positions of components thereof, and then communicate the respective orientations or positions to at least one controller.

The controller, in turn, operably communicates with the propulsion system of the vehicle to control the state of the propulsion system, including an activated state in which the propulsion system can propel the vehicle or a deactivated state in which the propulsion system is not fully or partially operational, such as when the motor and/or engine is not started or the motor and/or engine is not turned over.

The system of the present invention switches the controller between multiple conditions that affect the control, and the state, of the propulsion system. In the deactivated condition, the controller and the sensors preferably off and non-operational. In another of these various conditions, the controller is in a pre-activation condition, which includes, for example, an “initial” condition and a “ready” condition. In some embodiments the “initial” condition includes when an unlocking device is inserted in the ignition, or more preferably, when the unlocking device unlocks the power supply. The “initial” condition preferably includes having the controller powered on and/or the interlock sensors operational, i.e., powered on and able to sense. In a more preferred embodiment, the “initial” condition begins when the interlock sensors are operational. The propulsion system is preferably in a deactivated state when the controller is in the “initial” condition.

The “ready” condition preferably includes when the interlock sensors are satisfied, as discussed below, to when the sequence sensors become operational. In alternative embodiments, the order of powering up of the sequence sensor and the interlock sensors can be altered. In other alternative embodiments, the sequence sensors become operational in the “initial” condition and the interlock sensors become operational in the “ready” condition.

The controller also switches to an activated condition, which preferably includes a “go” condition, in which the propulsion system is placed in an activated state.

In some embodiments, the controller also is operably connected to a messaging system, such as a display, to provide the operator of the vehicle with visual or audio information about the condition of the propulsion system.

As used herein, the starting process encompasses when the propulsion system is off (i.e., deactivated state) to the time when the throttle activated is “hot” and can be controlled to operate the motor in a predetermined manner, and preferably to have full control over motor power (i.e., activated state). In the deactivated state, the propulsion system is preferably not activatable or not fully activatable, and the steering controls in the embodiment are locked. In alternate embodiments, the start process encompasses any period between which the propulsion system is in the deactivated state and the propulsion system enters the activated state. In certain embodiments, an unlocking device, such as a key, allows the vehicle to enter the deactivated state of the propulsion state, and allows the sensor system to be operable, preferably in the “initial” and/or “ready” conditions.

Generally, the present invention relates to an activation system controlling the switching of conditions of the controller of the vehicle from one condition to at least one other condition, such as the deactivated condition to the ready condition. In some embodiments, there is no intermediate pre-activated condition, and the controller switches directly from the deactivated condition to the activated condition. In other embodiments, the start process is limited to the deactivated condition transitioning to the intermediate, pre-activated condition. In a preferred embodiment, a plurality of interlock sensors switch the condition of the propulsion system from the deactivated condition to the ready condition, and a plurality of sequence sensors switch the condition of the propulsion system from the ready condition to the activated condition.

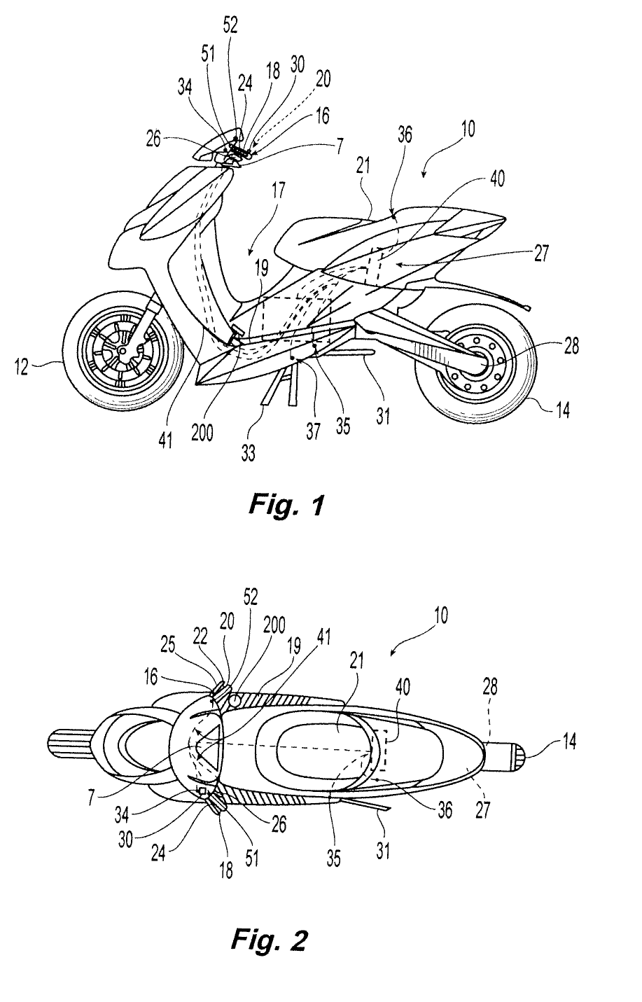

FIG. 1 shows an embodiment of an inventive vehicle, which is a scooter 10. The scooter 10 has two wheels, including a front steerable wheel 12 and a rear drive wheel 14. A propulsion system 27 can include, for example, an electric motor 28, a combustion motor, a combination electric and combustion motor, or other powered motor known in the art, including hybrid power sources that can use fuel cells. The propulsion system 27 is operably connected to at least one wheel 12 or 14, and in some embodiments, to an electrical powering device 42, such as a battery. In some variations, the propulsion system 27 is controlled by a throttle 22, which is “hot” when it has control of the propulsion system 27. The front wheel 12 is steerable by a handle bar 16 having a right handle 20 and a left handle 18, and the scooter 10 can be braked by at least one hand brake lever 24 and 25. In some variations, the scooter can be braked by a foot pedal 200. In some variations, the foot pedal 200 is located on one side of the scooter 10 near the front of a rider's foot, so that a rider could readily press the pedal 200 with the bottom of the rider's foot.

This embodiment of the present invention as illustrated in FIG. 1 includes sequence sensors 51 and 52 that operably communicate via communication cables 41 with at least one controller 40, which receives sequence signals and switches conditions of the propulsion system, e.g., to an activation condition, upon receiving the sequence signals in a predetermined sequence. The sequence sensors 51 and 52 may be placed in various locations on the scooter 10, preferably at portions of the scooter that physically interface with the rider. Preferred sequence sensors 51 and 52 are associated with the handle bar 16, such as in the right handle 20, the left handle 18, the left hand brake lever 24, and/or the right hand brake lever 25 are optional, and more preferably are on the left and right brake levers 24 and 25. In certain embodiments, the sequence sensors 51 and 52 are integrated within the brake levers 24 and 25 and the handles 18 and 20.

Preferably, once the controller 40 and propulsion system 27 are in a ready (i.e., pre-activation) condition, the operator can switch the condition of the propulsion system 27 to the activation condition by manipulating the handle bar 16, such as by operating the left hand brake lever 24 and the right hand brake lever 25, preferably in a predetermined sequence which can include operating each brake more than once. In one embodiment, the controller 40 is configured such that receipt of the sequence signals from the sequence sensors 51 and 52 does not switch the condition of the controller to the activation condition unless the controller 40 is in the pre-activation condition. The components 18, 20, and 24-25 represent user manipulable components, as discussed below.

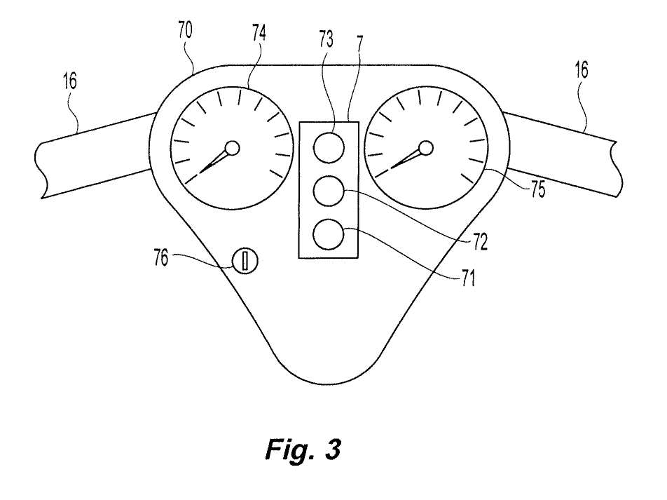

FIG. 3 shows an exemplary rider display console 70 for the scooter 10. The rider display console 70 includes a speedometer 74 and other vehicle performance gauges, such as a RPM meter 75, as well as an ignition switch 76, suitable for insertion of a conventional key or unlocking device. In some embodiments of the present invention, the rider display console 70 the scooter 10 includes, one or more messaging units 7, such as a singular display, such as a liquid display crystal (LCD) display, preset icons, lights, as shown in 71-73, representing icons for a deactivated condition, a pre-activation condition, preferably the “initial” and “ready” conditions, and a “go” condition, or other audio/visual indicators, as generally known in the art accessible (e.g., viewable or hearable) to the operator and preferably located on or proximal to the handle bar 16. The messaging unit 7 may include pictorial or worded icons 71-73 that include a back light when activated, such as when the system switches conditions.

In some embodiments, the scooter 10 of the present invention includes a kill button 30, preferably disposed on or proximal to the handle bar 16. The location of the kill button 30 is generally limited to an area on the scooter 10 accessible and operable by an operator, most preferably near the operator's hand when on the throttle. Conventionally, the motorcycle kill button 30 is in communication with the vehicle's ignition, when a combustion engine is used, or is connected to open and close a power circuit to the motor. When the kill button 30 is “open” (i.e., activated or turned on), the scooter 10 will not start or run and the propulsion system 27 will be deactivated or remain deactivated. When the kill button 30 is closed, i.e., in a RUN mode, the propulsion system can be activated. Accordingly, in preferred embodiments, the kill button 30 is one interlock sensor (as discussed in detail below), controlling the deactivation and activation states of the propulsion system 27.

In the embodiment shown, the scooter 10 has a pass-through 17 for facilitating mounting and seating a rider so the rider's legs can be passed therethrough. The pass-through 17 preferably has a height of more than about half of the height between foot platform 19 and the portion 21 of the seat where the driver sits, although different heights can be used. In a motorcycle embodiment, no pass-through is provided. The scooter also includes a side stand 31 and/or a center stand 33, which stabilize and retain the scooter 10 in an upright position when at rest, and are retractable during use of the scooter 10.

In the embodiment of FIG. 1, the scooter 10 includes a plurality of interlock sensors 34-37 disposed about the scooter 10. These interlock sensors 34-37 are preferably associated with components of the scooter 10 that are related to safety, that ensure that the scooter 10 is in a position to drive, and/or that ensure that the operator is in a position to ride the scooter 10 upon activation of the controller 40 and/or activation of the propulsion system 27. In an alternative embodiment, the interlock sensors 34-37 are disposed on other operator manipulable portions, the operation of which preferably affects the safety or reliability of the scooter 10. Operator manipulable portions of the scooter 10 can include, for example, buttons, levers, pedals, covers, etc., which provide information to the system based on their position or status, such as on/off, open/closed, received/unreceived signals.

A side stand sensor 35 is preferably operably connected to a side stand 31. The side stand 31 is an operator manipulable portion because the operator can retract the side stand 31, such as before driving and preferably during starting, and unfold the side stand 31 to an extended position during rest to stabilize the vehicle 10 when the propulsion system 27 is deactivated, the vehicle is stopped, or the operator dismounts the vehicle 10. Accordingly, in each location, the sensors 34-37 detect whether the corresponding operator-manipulable portion is in a drivable position (e.g., side stand 31 is retracted) or in a stationary position (e.g., side stand 31 is extended). Preferably, if the sensors 34-37 detect a drivable position, the sensors 34-37 send signals to a controller 40 indicating that the parameter is satisfied.

Other exemplary sensors associated with operator manipulable portions include a kill button sensor 34 operably connected to, preferably integrated with, and more preferably serving as, the kill button (i.e., the kill switch) 30, a center stand sensor 37 operably connected to the center stand 33, which is preferably retractable, and a seat sensor 36 operably connected to the seat 21 to detect whether the operator is sitting thereon, preferably by means of a pressure activated sensor, a luggage sensor operably connected to a luggage compartment cover to ensure closing, and a pedal sensor operably connected to one or more foot pedals.

Preferably, the scooter 10 includes a controller 40, such as a computer processor or other electronic component, that can transmit, receive, and process signals as known in the art, and that is operably connected through connectors 41 to at least the sensors 34-37, the propulsion system 27, sequence sensors 51 and 52, and optionally, the messaging unit 7. The types of connectors 41 include those known to one skilled in the art, such as communication cables or wireless connections that are able to carry signals from the sensors 34-37, 51 and 52 to the controller 40, messaging information from the controller 40 to the messaging unit 7, or propulsion system state information from the controller 40 to the propulsion system 27, for example.

In preferred embodiments, sensors, preferably the interlock sensors 34-37, transmit signals to the controller 40 when the sensors 34-37 are closed, and do not transmit signals when the sensors 34-37 are open. In these embodiments, the positions of the sensors 34-37 correspond to the drivability of the vehicle 10. In an open position, the scooter 10 cannot be propelled safely and/or the operator is not positioned properly; in a closed position, safe operation or proper operator position is determined. For example, when the side stand 31 is retracted, the scooter 10 can be driven by the operator, and in turn, the sensor 35 is in a closed position, thereby allowing transmission of the signal to the controller 40. Accordingly, when the side stand 31 is extended, the sensor is in a closed position. In alternative embodiments, the open/closed designation may be reversed, such that sensors 34-37 transmit signals if the sensors 34-37 are in the open position, and do not transmit signals in the closed position.

The form of the signals communicated between the parts of the vehicle, such as the sensors 34-37, 51 and 52 and the manipulable portions 18,20-21, 24-25, 30-31, and 33, as illustrated in this embodiment, are generally known in the art and can include hydraulic, pneumatic, and preferably electric signals. Sensors 34-37, 51 and 52 receiving the signals may stand alone, be operably connected to other transmitting or sensing devices, or may preferably be integrated with other operator manipulable portions of the vehicle 18, 20-21, 24-25, 30-31, and 33.

Signals transmitted between sensors 34-37 and the controller 40 are preferably transmitted in parallel, but can alternatively be transmitted in series, or in a combination of series and parallel. In one embodiment, the signal between the plurality of interlock sensors 34-37 and the controller 40 transmits in parallel. As a result, the controller 40 processes each signal received from each respective sensor 34-37, and preferably when all undetermined signals are received, the controller 40 switches from the “initial” condition to the “ready” condition.

In another embodiment, the signal between the plurality of interlock sensors 34-37 travels serially through each of the plurality of interlock sensors 34-37 successively until received by the controller 40, which then switches the condition of the controller 40, preferably from an “initial” condition to the “ready” condition. In some embodiments, the controller 40 only receives a signal if a predetermined number, preferably all, of the interlock sensors 34-37 are in a satisfactory position (e.g., all the sensors 34-37 are closed, indicating that the side stand 31 and/or center stand 33 are retracted, the kill button 30 is off (or conventionally in a RUN mode) and the seat 21 is in an operator rideable position).

The seat sensor 36, for example, is useful to detect the position of the seat 21 or the presence of the operator on the seat 21, using a pressure activated sensor, for example. In an embodiment in which an area under the seat 21 can be used for storage, the seat 21 can be hinged, removed, slid, or otherwise moved to provide access to the storage area. To ride the scooter 10, however, the seat 21 should be in the closed position, thereby allowing the operator to sit on the seat 11, and the appropriate sensor 36 thus senses that the storage area is closed. In another variation, the seat sensor 36 can be used to sense whether the operator is sitting on the seat 21, thereby indicating that the operator is in a safe position to start the vehicle 10.

In the embodiment shown in FIG. 2, the handle bar 16 has a twist grip throttle 22 located on the right handle 20 and the hand brake lever 24 located either on the left handle 18, as in the illustrated embodiment. This configuration is typical of European motor scooters, although this positioning is altered in other embodiments, whereby a brake lever can be provided on the right handle 20 or both handles 20 and 18. Additionally, located below the handle bar 16 and extending generally parallel to the left handle 18 is a thumb-switch or thumb-lever 26. The thumb-lever 26 preferably is mounted near the handle so that a rider can readily press the lever with the thumb of the rider's hand.

Embodiments of the present invention preferably require the operator to assume a riding position. The preferred riding position on the vehicle involves sitting or mounting the vehicle such that the operator has control of the steering controls and balance of the vehicle sufficient to maintain the vehicle substantially upright. For example, for two wheel drive vehicles (e.g., motorcycles), the user would preferably mount the vehicle in either a sitting or standing position with one foot positioned on either side of the vehicle and with at least one hand on the steering control (i.e., the handle bar).

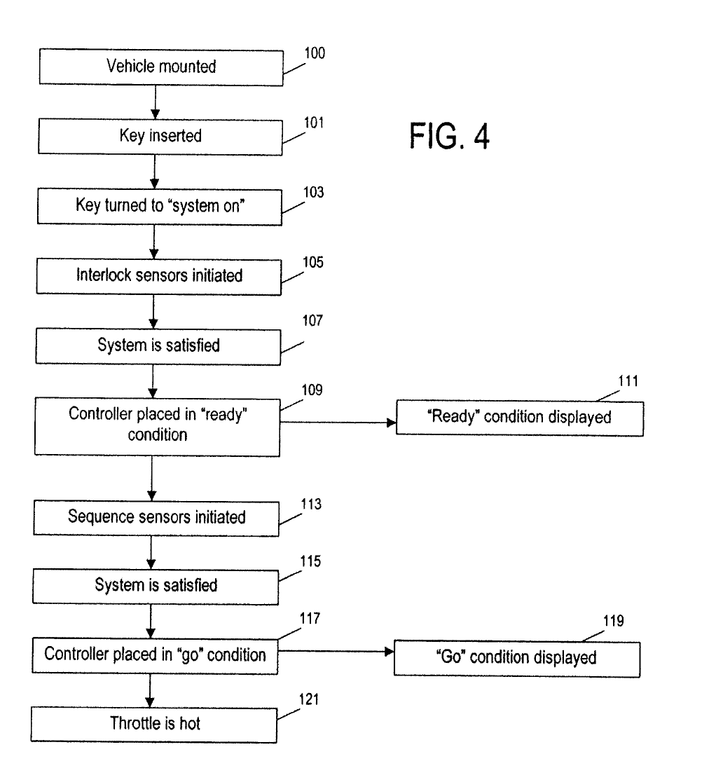

FIG. 4 presents an overview flow diagram of the safety process, including the interlock and sequence sensors. Preferably after the vehicle is mounted by one or more operators, as shown in step 100, a key is inserted, as shown in step 101, and turned to initiate system activation, as shown in step 103. In preferred embodiments, the activation of the system corresponds to the “initial” condition of the controller and a deactivated state of the propulsion system in which the throttle is non-functional and cannot operate the propulsion system, i.e., the throttle is not hot.

The interlock sensors also activate and automatically sense the presence of whether the predetermined parameters are met in preferred embodiments. In one preferred embodiment, electric signals are transmitted to the controller from each interlock sensor switch, which operates in a closed position, indicating that the parameter detected by the sensor is in a safe position for operation of the propulsion system. For example, the controller receives a signal from the kill button when the kill button is in the RUN mode, and determines that the switch is closed. In this embodiment, the signals are electrical, and the method of transmitting, receiving, and detecting electrical signals are known to one skilled in the art. Accordingly, in preferred embodiments, a “closed” position in the two-position sensor, allows a signal to proceed through the sensor, whereas an “open” sensor causes the signal to terminate. In some variations, the signal can be the stopping of the electrical current.

As shown in step 105, the interlock sensors are initiated and send signals to the controller. Upon receiving signals from preferably all of the interlock sensors, the system is satisfied, as shown in step 107, and the controller is placed in the “ready” condition, as shown in step 109. In preferred embodiments, the propulsion system remains in a deactivated state and the throttle is not hot at this step. In preferred embodiments, the controller signals a display to indicate the “ready” condition the operator, as shown in step 111.

At the same time as the interlock sensors operate, preferably after the interlock sensors are satisfied, and more preferably subsequently to entry of the controller to the “ready” condition, as illustrated in FIG. 4, the controller is able to receive signals initiated by the sequence sensors, as shown in step 113. The operator enters a predetermined sequence, the sequence sensors signal the controller. If the signaled sequence matches the predetermined sequence, the system is satisfied, as shown in step 115, and the controller is placed in the activated “go” condition, as shown in step 117. In the “go” condition, the throttle is hot, as shown in step 121, allowing the operator to regulate power to the propulsion system to move the vehicle. Preferably, a messaging system, displays the “go” condition to the operator, as shown in step 119.

In alternative embodiments, the controller communicates with the sensors, such that there is -two-way communication between the sensors and the controller. The controller can send signals to the sensors in addition to the sensor being able to send signals to the controller. In certain alternative embodiments, the interlock sensors are operable upon initiation by the controller in an “initial” condition and in a “ready” condition.

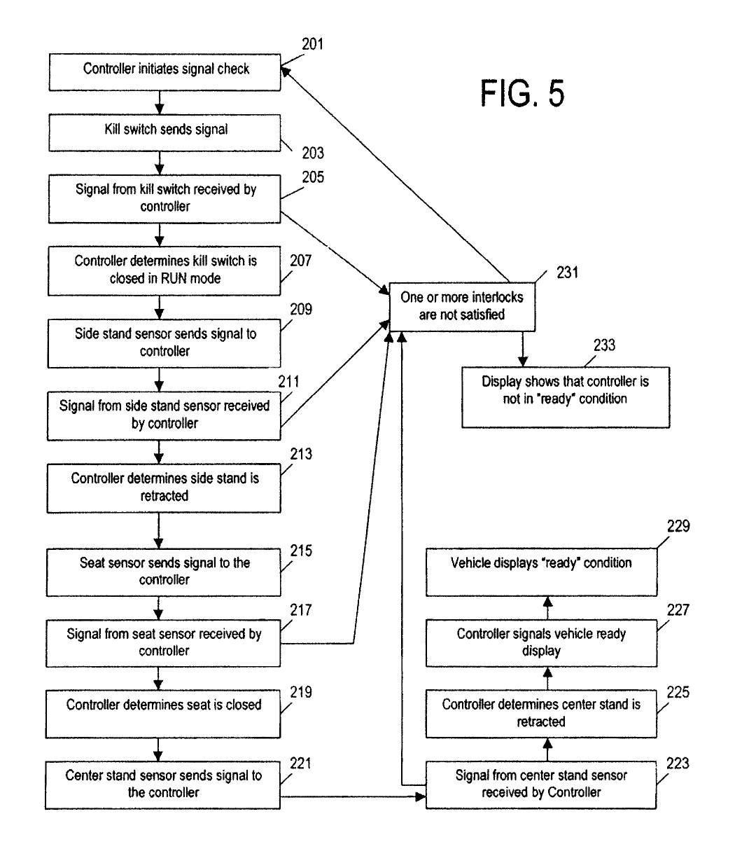

FIG. 5 provides exemplary functionality of the interlock sensor. Preferably interlock sensors are operational when the controller switches to the “initial” condition in which the controller remains in a pre-activation condition and the propulsion system remains in a deactivated state. In certain embodiments, the “initial” condition follows an event and/or action allowing the controller to enter a pre-activation condition from a deactivated condition, such as turning of the ignition key. Once in the pre-activation condition, such as the “initial” condition, the controller is operational and initiates the interlock system check, as shown in step 201.

In this embodiment, signals are sent from four interlock sensors, all of which must be satisfied to switch the condition of the controller to the “ready” condition. The kill button, which is commonly referred to as the kill switch, sends a signal when it is in the RUN mode, as shown in step 203. The controller receives the signal from the kill switch, in step 205, thereby determining the kill switch is closed (i.e., in the RUN mode), as shown in step 207. In step 209, the side stand sensor sends a signal to the controller. The controller receives the signal from the side stand, as shown in step 211, and by receiving the signal, the controller determines that the side stand is retracted, as shown in step 213. The seat sensor also sends a signal to the controller, as shown in step 215, and the signal is received by the controller, as shown in step 217, indicating, for example, whether the seat is in a position to allow the operator to sit on it or whether the operator is in fact sitting on the seat. Upon receiving the signal, the controller determines that the seat is closed, as shown in step 219. Additionally, in the embodiment illustrated by FIG. 5, the center stand sensor sends a signal to the controller and the signal is received by the controller, as shown in steps 221 and 223, respectively. The controller determines that the center stand is retracted, as shown in step 225.

In preferred embodiments involving the interlock sensors, if each interlock sensor signal is received by the controller, the vehicle is in a safe or predetermined position to activate the propulsion system or to switch the controller to another condition. Accordingly, the controller enters the propulsion system into a “ready” condition. The controller signals the display, as shown in step 227, to display the “ready” condition to the operator, as shown in step 229.

If the controller determines that one or more interlock sensors are not satisfied, as shown in step 231, the controller initiates the signal check again, as shown in step 201. Accordingly, the interlock sensors continuously operate until the interlock sensors are satisfied, or until the operator returns the controller to the deactivated condition by taking the key out of the ignition for example. Additionally, the controller may optionally send a message to the operator, as shown in step 235, reporting the status of the controller condition, as shown in step 233.

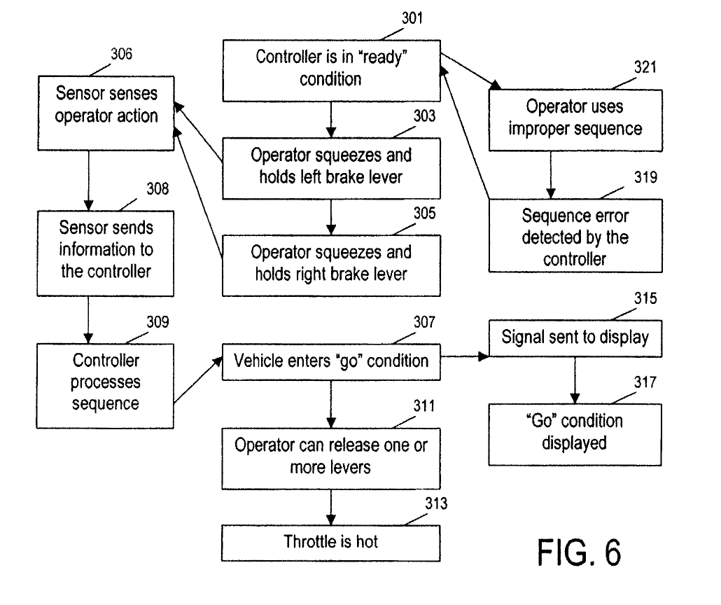

FIG. 6 further describes an exemplary embodiment involving the functionality of the sequence sensors, which, if satisfied, switch the controller from the “ready” condition to the activated “go” condition. At step 301, the controller is preferably in the “ready” condition. In some variations, however, the vehicle may be in a deactivated condition at the start of the sequence sensing.

In the illustrated embodiment, the predetermined sequence that switches the condition of the propulsion system includes squeezing and holding the left brake, squeezing and holding the right brake, and releasing the brake levers. In other embodiments, the sequence may be modified in any manner, including changes in the order of the steps, addition/deletion of steps, and/or changes in the location of the sequence sensors and on operator manipulable portions of the vehicle. In this embodiment, in accordance with the predetermined sequence, the operator squeezes and holds the left brake lever, as shown in step 303. The operator then squeezes and holds the left brake lever, as shown in step 305. The sequence sensors sense the actions taken by the operator, as shown in step 306, and transmit the sensed information to the controller, as shown in step 308.

The controller processes the sequence to confirm it with a predetermined sequence, as shown in step 309. Once confirmed, the controller switches conditions, such as to the “ready” condition, if the vehicle was previously in a deactivated condition, or preferably to the “go” condition, as shown in step 307, if the controller was either in the “ready” condition. The operator can release one or more of the levers, as shown in step 311, and preferably a signal is sent to the messaging unit via the controller, as shown in step 315, which displays the condition, as shown in step 317. The throttle is hot, as shown in step 313, when the vehicle is in the “go” condition. Accordingly the propulsion system enters an activation state.

If the operator uses an improper sequence, as shown in step 321, the controller detects a sequence error, as shown in step 319, and the controller preferably remains in “ready” condition, as shown in step 301. In an alternative embodiment, the controller returns to a deactivated condition after the error is processed.

Exemplary embodiments of the present invention have now been described in accordance with the above advantages. It will be appreciated that these examples are merely illustrative of the invention. Many variations and modifications will be apparent to those of ordinary skill in the art without departing from the systems and methods disclosed and taught by the present invention.

What is claimed is:

1. A propulsion system activation device, comprising:
a plurality of sequence sensors each associable with a plurality of user-manipulable portions of a vehicle for sensing positions thereof and transmitting a plurality of sequence signals based on the sensed positions; and
a controller having a pre-activation condition and being operably connected to the sequence sensors for receiving the transmitted sequence signals and switching to an activation condition upon receiving the sequence signals in a predetermined sequence, the controller being connectable to a vehicle propulsion system for activating the propulsion system when in the activation condition.

2. The propulsion system activation device of claim 1, wherein the predetermined sequence includes sequence signals that indicate that at least one of the user-manipulable portions is operated more than once in the sequence.

3. The propulsion system activation device of claim 1, wherein at least one of the manipulable portions is a control necessary for driving the vehicle.

4. The propulsion system activation device of claim 3, wherein the control for driving the vehicle is a brake control.

5. The propulsion system activation device of claim 4, wherein the control comprises first and second brake controls, and the predetermined sequence comprises operating the first brake control, operating the second brake control, and releasing both brake controls.

6. The propulsion system activation device of claim 3, wherein the control for driving the vehicle is a throttle control.

7. The propulsion system activation device of claim 1, wherein the propulsion system comprises a electric motor configured for propelling the vehicle and an electric power source configured to provide electric power to the motor.

8. The propulsion system activation device of claim 7, wherein the controller is connected to the propulsion system to control the amount of power delivered to the motor.

9. The propulsion system activation device of claim 1, wherein the vehicle comprises a handle bar and at least one steerable wheel associated with the handle bar for steering the vehicle.

10. The propulsion system activation device of claim 1, further comprising a messaging unit operably connected to the controller for indicating conditions of the controller to a user.

11. The propulsion system activation device of claim 1, further comprising a plurality of interlock sensors that are configured for sensing a position of at least one user-manipulable portion of the vehicle and transmitting a plurality of interlock signals based on said sensed positions, wherein pre-activation condition includes initial and ready conditions in which the controller is configured for maintaining the propulsion system in a deactivated state, the controller being configured to switch from the initial condition to the ready condition upon receiving all of the interlock sensor signals.

12. The propulsion system activation device of claim 11, wherein the controller is configured such that receipt of the sequence signals from the sequence sensor does not switch to the activation condition unless the controller is in the ready condition when the predetermined sequence is detected.

13. A vehicle, comprising:
a vehicle body;
a seat on said body for supporting a rider;
the propulsion system of claim 11 configured for propelling the vehicle body; and
a stand associated with the body to stabilize the body in an upright position when not mounted by the rider;
wherein the plurality of interlock system sensors are configured for detecting a position of the vehicle stand and a weight of the rider on the seat.

14. The propulsion system activation device of claim 13, wherein the controller is configured such that receipt of the sequence signals from the sequence sensor does not switch to the activation condition unless the controller is in the pre-activation condition when the predetermined sequence is detected.

15. A method of operating a vehicle, comprising:
in a controller, detecting positions of at least one user-manipulable portion of a vehicle;
switching the controller to a ready condition upon detection of predetermined positions of the user-manipulable portion;
in the ready condition, the controller detecting a sequence of operation of a plurality of user-manipulable portions of the vehicle;
upon detection of said sequence matching a predetermined sequence, switching the controller to an activation condition; and
the controller activating a vehicle propulsion system when the controller is in the activation condition.

16. The method of claim 15, further comprising displaying the states of the propulsion system.
